(19) United States
(12) Patent Application Publication
(10) Pub. No.: US 2026/0343342 A1
(43) Pub. Date: Oct. 29, 2026

(54) LOWER LAYER MOBILITY RELEASE PREPARATION

(71) Applicant: Nokia Technologies Oy, Espoo (FI)

(72) Inventors: Halit Murat GÜRSU, Munich (DE); Jedrzej STANCZAK, Wroclaw (PL); Panagiotis SPAPIS, Munich (DE); Umur KARABULUT, Munich (DE); Ahmad AWADA, Munich (DE); Subramanya CHANDRASHEKAR, Bangalore (IN); Srinivasan SELVAGANAPATHY, Bangalore (IN); Alperen GUNDOGAN, Munich (DE); Andres ARJONA, Tokyo (JP)

(21) Appl. No.: 19/114,516

(22) PCT Filed: Sep. 20, 2023
(86) PCT No.: PCT/EP2023/075946

§ 371 Date: Mar. 24, 2025

(30) Foreign Application Priority Data
Sep. 29, 2022 (IN) 202241055894

(51) Int. Cl. H04W 36/00

(52) U.S. Cl. CPC H04W 36/0072; H04W 36/0058

(57) ABSTRACT

There is provided an apparatus comprising means for determining, at a distributed unit of a serving node of a user equipment, that a release condition for a target cell prepared for lower layer mobility of the user equipment is met and in response to determining that the release condition is met, causing the target cell to be released and an apparatus comprising means for determining for at least one cell prepared for lower layer mobility for a user equipment, a release condition and providing an indication of the release condition to a distributed unit of a serving node of the user equipment.

### RELATED APPLICATION

This application claims priority to PCT Patent Application No. PCT/EP2023/075946, filed 20 Sep. 2023, which claims priority from India Application No. 202241055894, filed on 29 Sep. 2022, which is incorporated herein by reference in its entirety.

### FIELD

The present application relates to a method, apparatus, system and computer program and in particular but not exclusively to lower layer mobility (LLM) release preparation.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). Some wireless systems can be divided into cells, and are therefore often referred to as cellular systems.

A user can access the communication system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is UTRAN (3G radio). Other examples of communication systems are the long-term evolution (LTE) of the Universal Mobile Telecommunications System (UMTS) radio-access technology and so-called 5G or New Radio (NR) networks. NR is being standardized by the 3rd Generation Partnership Project (3GPP).

### SUMMARY

In a first aspect there is provided an apparatus comprising means for determining, at a distributed unit of a serving node of a user equipment, that a release condition for a target cell prepared for lower layer mobility of the user equipment is met and, in response to determining that the release condition is met, causing the target cell to be released.

Means for causing the target cell to be released may comprise means for providing an indication to a centralised unit indicating release preparation of the target cell.

The indication to the centralised unit may comprise an identifier of the target cell or a lower layer mobility preparation identifier.

The apparatus may comprise means for receiving, at the distributed unit of the serving node, at least one layer 1 measurement value from the user equipment and determining that the release condition for the target cell is met based on the at least one layer 1 measurement value.

Means for causing the target cell to be released may comprise means for providing an indication to the user equipment to release configuration of the target cell.

The indication to the user equipment may be provided in a layer 1 message.

The layer 1 message may comprise a media access control, MAC, control element, CE or downlink control information, DCI, indication.

The indication to the user equipment may comprise an indication of whether layer 1 measurements for the target cell should be continued.

The indication to the user equipment may comprise an identifier of the target cell or a lower layer mobility preparation identifier

The release condition may comprise at least one of a threshold value, an offset value, a number of target cells and a target cell load.

The threshold value may comprise at least one of reference signal received power, reference signal received quality and layer 1 signal to interference and noise ratio.

The apparatus may comprise means for receiving, at the distributed unit of the serving node from a centralised unit, an indication of the release condition.

In a second aspect there is provided a method comprising determining, at a distributed unit of a serving node of a user equipment, that a release condition for a target cell prepared for lower layer mobility of the user equipment is met and, in response to determining that the release condition is met, causing the target cell to be released.

Causing the target cell to be released may comprise providing an indication to a centralised unit indicating release preparation of the target cell.

The indication to the centralised unit may comprise an identifier of the target cell or a lower layer mobility preparation identifier.

The method may comprise receiving, at the distributed unit of the serving node, at least one layer 1 measurement value from the user equipment and determining that the release condition for the target cell is met based on the at least one layer 1 measurement value.

Causing the target cell to be released may comprise providing an indication to the user equipment to release configuration of the target cell.

The indication to the user equipment may be provided in a layer 1 message.

The layer 1 message may comprise a media access control, MAC, control element, CE or downlink control information, DCI, indication.

The indication to the user equipment may comprise an indication of whether layer 1 measurements for the target cell should be continued.

The indication to the user equipment may comprise an identifier of the target cell or a lower layer mobility preparation identifier

The release condition may comprise at least one of a threshold value, an offset value, a number of target cells and a target cell load.

The threshold value may comprise at least one of reference signal received power, reference signal received quality and layer 1 signal to interference and noise ratio.

The method may comprise receiving, at the distributed unit of the serving node from a centralised unit, an indication of the release condition.

In a third aspect there is provided an apparatus comprising: at least one processor and at least one memory storing instructions that, when executed by the at least one processor, cause the apparatus at least to determine, at a distributed unit of a serving node of a user equipment, that a release condition for a target cell prepared for lower layer mobility of the user equipment is met and in response to determining that the release condition is met, cause the target cell to be released.

The apparatus may be configured to provide an indication to a centralised unit indicating release preparation of the target cell.

The indication to the centralised unit may comprise an identifier of the target cell or a lower layer mobility preparation identifier.

The apparatus may configured to receive, at the distributed unit of the serving node, at least one layer 1 measurement value from the user equipment and determining that the release condition for the target cell is met based on the at least one layer 1 measurement value.

The apparatus may be configured to provide an indication to the user equipment to release configuration of the target cell.

The indication to the user equipment may be provided in a layer 1 message.

The layer 1 message may comprise a media access control, MAC, control element, CE or downlink control information, DCI, indication.

The indication to the user equipment may comprise an indication of whether layer 1 measurements for the target cell should be continued.

The indication to the user equipment may comprise an identifier of the target cell or a lower layer mobility preparation identifier

The release condition may comprise at least one of a threshold value, an offset value, a number of target cells and a target cell load.

The threshold value may comprise at least one of reference signal received power, reference signal received quality and layer 1 signal to interference and noise ratio.

The apparatus may be configured to receive, at the distributed unit of the serving node from a centralised unit, an indication of the release condition.

In a fourth aspect there is provided a computer readable medium comprising instructions which, when executed by an apparatus, cause the apparatus to perform at least the following:
determining, at a distributed unit of a serving node of a user equipment, that a release condition for a target cell prepared for lower layer mobility of the user equipment is met; and
in response to determining that the release condition is met, causing the target cell to be released.

Causing the target cell to be released may comprise providing an indication to a centralised unit indicating release preparation of the target cell.

The indication to the centralised unit may comprise an identifier of the target cell or a lower layer mobility preparation identifier.

The apparatus may be caused to perform receiving, at the distributed unit of the serving node, at least one layer 1 measurement value from the user equipment and determining that the release condition for the target cell is met based on the at least one layer 1 measurement value.

Causing the target cell to be released may comprise providing an indication to the user equipment to release configuration of the target cell.

The indication to the user equipment may be provided in a layer 1 message.

The layer 1 message may comprise a media access control, MAC, control element, CE or downlink control information, DCI, indication.

The indication to the user equipment may comprise an indication of whether layer 1 measurements for the target cell should be continued.

The indication to the user equipment may comprise an identifier of the target cell or a lower layer mobility preparation identifier

The release condition may comprise at least one of a threshold value, an offset value, a number of target cells and a target cell load.

The threshold value may comprise at least one of reference signal received power, reference signal received quality and layer 1 signal to interference and noise ratio.

The apparatus may be caused to perform receiving, at the distributed unit of the serving node from a centralised unit, an indication of the release condition.

In a fifth aspect there is provided a non-transitory computer readable medium comprising program instructions for causing an apparatus to perform at least the method according to the second aspect.

In a sixth aspect there is provided an apparatus comprising means for determining for at least one cell prepared for lower layer mobility for a user equipment, a release condition and providing an indication of the release condition to a distributed unit of a serving node of the user equipment.

The release condition may comprise at least one of a threshold value, an offset value, a number of target cells and a target cell load.

The threshold value may comprise at least one of reference signal received power, reference signal received quality and layer 1 signal to interference and noise ratio.

The apparatus may comprise means for providing a measurement configuration to the user equipment for enabling evaluation of the release condition.

The apparatus may comprise means for providing an indication of the release condition to the user equipment.

The apparatus may comprise means for determining the release condition based on at least one of reference signal received power threshold, the serving node associated with the target cell, the total number of prepared cells for the user equipment and the load condition of the serving node associated with the target cell.

The release condition may be the same or different for each of a plurality of cells prepared for lower layer mobility for a user equipment.

The target cell may be associated with the distributed unit or a further distributed unit.

In a seventh aspect there is provided an apparatus comprising means for receiving, from a centralised unit at a distributed unit of a serving node of a user equipment, an indication of a release condition for at least one cell prepared for lower layer mobility for the user equipment.

The release condition may comprise at least one of a threshold value, an offset value, a number of target cells and a target cell load.

The threshold value may comprise at least one of reference single received power, reference signal received quality and layer 1 signal to interference and noise ratio.

The release condition may be determined based on at least one of reference signal received power threshold, the serving node associated with the target cell, the total number of prepared cells for the user equipment and the load condition of the serving node associated with the target cell.

The release condition may be the same or different for each of a plurality of cells prepared for lower layer mobility for a user equipment.

The target cell may be associated with the distributed unit or a further distributed unit.

In an eighth aspect there is provided a method comprising determining for at least one cell prepared for lower layer mobility for a user equipment, a release condition and providing an indication of the release condition to a distributed unit of a serving node of the user equipment.

The release condition may comprise at least one of a threshold value, an offset value, a number of target cells and a target cell load.

The threshold value may comprise at least one of reference single received power, reference signal received quality and layer 1 signal to interference and noise ratio.

The method may comprise providing a measurement configuration to the user equipment for enabling evaluation of the release condition.

The method may comprise providing an indication of the release condition to the user equipment.

The method may comprise determining the release condition based on at least one of reference signal received power threshold, the serving node associated with the target cell, the total number of prepared cells for the user equipment and the load condition of the serving node associated with the target cell.

The release condition may be the same or different for each of a plurality of cells prepared for lower layer mobility for a user equipment.

The target cell may be associated with the distributed unit or a further distributed unit.

In a ninth aspect there is provided a method comprising receiving, from a centralised unit at a distributed unit of a serving node of a user equipment, an indication of a release condition for at least one cell prepared for lower layer mobility for the user equipment.

The release condition may comprise at least one of a threshold value, an offset value, a number of target cells and a target cell load.

The threshold value may comprise at least one of reference single received power, reference signal received quality and layer 1 signal to interference and noise ratio.

The release condition may be determined based on at least one of reference signal received power threshold, the serving node associated with the target cell, the total number of prepared cells for the user equipment and the load condition of the serving node associated with the target cell.

The release condition may be the same or different for each of a plurality of cells prepared for lower layer mobility for a user equipment.

The target cell may be associated with the distributed unit or a further distributed unit.

In a tenth aspect there is provided an apparatus comprising: at least one processor and at least one memory storing instructions that, when executed by the at least one processor, cause the apparatus at least to determine for at least one cell prepared for lower layer mobility for a user equipment, a release condition and provide an indication of the release condition to a distributed unit of a serving node of the user equipment.

The release condition may comprise at least one of a threshold value, an offset value, a number of target cells and a target cell load.

The threshold value may comprise at least one of reference single received power, reference signal received quality and layer 1 signal to interference and noise ratio.

The apparatus may be caused to provide a measurement configuration to the user equipment for enabling evaluation of the release condition.

The apparatus may be caused to provide an indication of the release condition to the user equipment.

The apparatus may be caused to determine the release condition based on at least one of reference signal received power threshold, the serving node associated with the target cell, the total number of prepared cells for the user equipment and the load condition of the serving node associated with the target cell.

The release condition may be the same or different for each of a plurality of cells prepared for lower layer mobility for a user equipment.

The target cell may be associated with the distributed unit or a further distributed unit.

In an eleventh aspect there is provided an apparatus comprising: at least one processor and at least one memory storing instructions that, when executed by the at least one processor, cause the apparatus at least to receive, from a centralised unit at a distributed unit of a serving node of a user equipment, an indication of a release condition for at least one cell prepared for lower layer mobility for the user equipment.

The release condition may comprise at least one of a threshold value, an offset value, a number of target cells and a target cell load.

The threshold value may comprise at least one of reference single received power, reference signal received quality and layer 1 signal to interference and noise ratio.

The release condition may be determined based on at least one of reference signal received power threshold, the serving node associated with the target cell, the total number of prepared cells for the user equipment and the load condition of the serving node associated with the target cell.

The release condition may be the same or different for each of a plurality of cells prepared for lower layer mobility for a user equipment.

The target cell may be associated with the distributed unit or a further distributed unit.

In a twelfth aspect there is provided a computer readable medium comprising instructions which, when executed by an apparatus, cause the apparatus to perform at least the following:
determining for at least one cell prepared for lower layer mobility for a user equipment, a release condition and providing an indication of the release condition to a distributed unit of a serving node of the user equipment.

The release condition may comprise at least one of a threshold value, an offset value, a number of target cells and a target cell load.

The threshold value may comprise at least one of reference single received power, reference signal received quality and layer 1 signal to interference and noise ratio.

The apparatus may be caused to perform providing a measurement configuration to the user equipment for enabling evaluation of the release condition.

The apparatus may be caused to perform providing an indication of the release condition to the user equipment.

The apparatus may be caused to perform determining the release condition based on at least one of reference signal received power threshold, the serving node associated with the target cell, the total number of prepared cells for the user equipment and the load condition of the serving node associated with the target cell.

The release condition may be the same or different for each of a plurality of cells prepared for lower layer mobility for a user equipment.

The target cell may be associated with the distributed unit or a further distributed unit.

In a thirteenth aspect there is provided a computer readable medium comprising instructions which, when executed by an apparatus, cause the apparatus to perform at least the following:
receiving, from a centralised unit at a distributed unit of a serving node of a user equipment, an indication of a release condition for at least one cell prepared for lower layer mobility for the user equipment.

The release condition may comprise at least one of a threshold value, an offset value, a number of target cells and a target cell load.

The threshold value may comprise at least one of reference single received power, reference signal received quality and layer 1 signal to interference and noise ratio.

The release condition may be determined based on at least one of reference signal received power threshold, the serving node associated with the target cell, the total number of prepared cells for the user equipment and the load condition of the serving node associated with the target cell.

The release condition may be the same or different for each of a plurality of cells prepared for lower layer mobility for a user equipment.

The target cell may be associated with the distributed unit or a further distributed unit.

In a fourteenth aspect there is provided a non-transitory computer readable medium comprising program instructions for causing an apparatus to perform at least the method according to the eighth or ninth aspect.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a schematic diagram of an example 5GS communication system;

FIG. 2 shows a schematic diagram of an example mobile communication device;

FIG. 3 shows a schematic diagram of an example control apparatus;

FIG. 4 shows a signalling diagram for an example L1/2 inter-cell mobility procedure;

FIG. 5 shows a signalling diagram for an example release procedure for LLM mobility;

FIG. 6 shows a flowchart for a method according to an example embodiment;

FIG. 7 shows a flowchart of a method according to an example embodiment;

FIG. 8 shows a signalling flow of a method according to an example embodiment.

### DETAILED DESCRIPTION

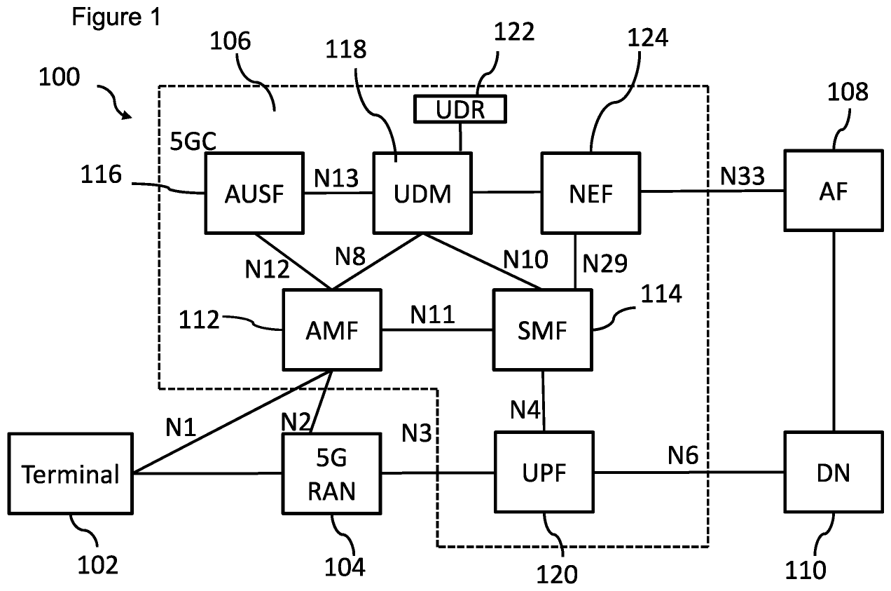

Before explaining in detail the examples, certain general principles of a wireless communication system and mobile communication devices are briefly explained with reference to FIGS. 1 to 3 to assist in understanding the technology underlying the described examples.

An example of a suitable communications system is the 5G or NR concept. Network architecture in NR may be similar to that of LTE-advanced. Base stations of NR systems may be known as next generation Node Bs (gNBs). Changes to the network architecture may depend on the need to support various radio technologies and finer QoS support, and some on-demand requirements for e.g. Quality of Service (QoS) levels to support Quality of Experience (QoE) for a user. Also network aware services and applications, and service and application aware networks may bring changes to the architecture. Those are related to Information Centric Network (ICN) and User-Centric Content Delivery Network (UC-CDN) 25 approaches. NR may use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

Future networks may utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

FIG. 1 shows a schematic representation of a 5G system (5GS) 100. The 5GS may comprise a user equipment (UE) 102 (which may also be referred to as a communication device or a terminal), a 5G radio access network (5GRAN) 104, a 5G core network (5GCN) 106, one or more application functions (AF) 108 and one or more data networks (DN) 110.

An example 5G core network (CN) comprises functional entities. The 5GCN 106 may comprise one or more access and mobility management functions (AMF) 112, one or more session management functions (SMF) 114, an authentication server function (AUSF) 116, a unified data management (UDM) 118, one or more user plane functions (UPF) 120, a unified data repository (UDR) 122 and/or a network exposure function (NEF) 124. The UPF is controlled by the SMF (Session Management Function) that receives policies from a PCF (Policy Control Function).

The CN is connected to a UE via the radio access network (RAN). The 5GRAN may comprise one or more gNodeB (GNB) distributed unit functions connected to one or more gNodeB (GNB) centralized unit functions. The RAN may comprise one or more access nodes.

A User Plane Function (UPF) referred to as PDU Session Anchor (PSA) may be responsible for forwarding frames back and forth between the DN and the tunnels established over the 5G towards the UE(s) exchanging traffic with the DN.

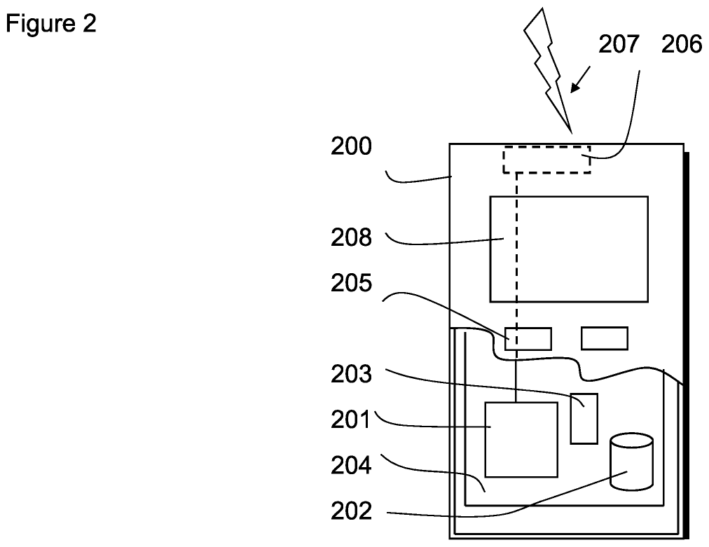

A possible mobile communication device will now be described in more detail with reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, voice over IP (VoIP) phones, portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), smart devices, wireless customer-premises equipment (CPE), or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

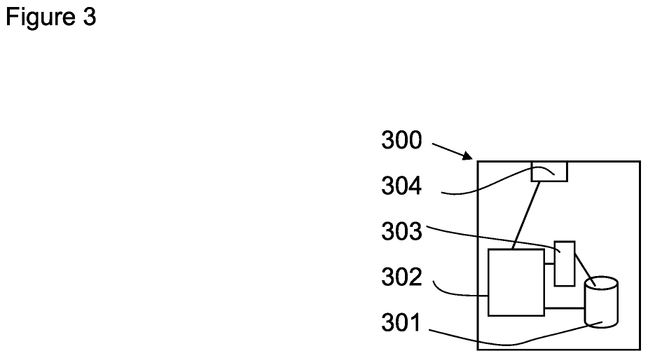

FIG. 3 shows an example of a control apparatus 300 for a communication system, for example to be coupled to and/or for controlling a station of an access system, such as a RAN node, e.g. a base station, eNB or gNB, a relay node or a core network node such as an MME or S-GW or P-GW, or a core network function such as AMF/SMF, or a server or host. The method may be implemented in a single control apparatus or across more than one control apparatus. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 300 can be arranged to provide control on communications in the service area of the system. The control apparatus 300 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head.

L1/2 inter-cell mobility is one of the upcoming objectives for mobility enhancement in Rel. 18. In L3 mobility procedures, the handover (HO) between two cells is decided by the Radio Resource Control (RRC) layer. In contrast, L1/2 inter-cell mobility is performed by the Media Access Control (MAC) layer terminated in the Distributed Unit (DU). L1/2 inter-cell mobility may also be referred to as Low, or lower, Layer Mobility (LLM).

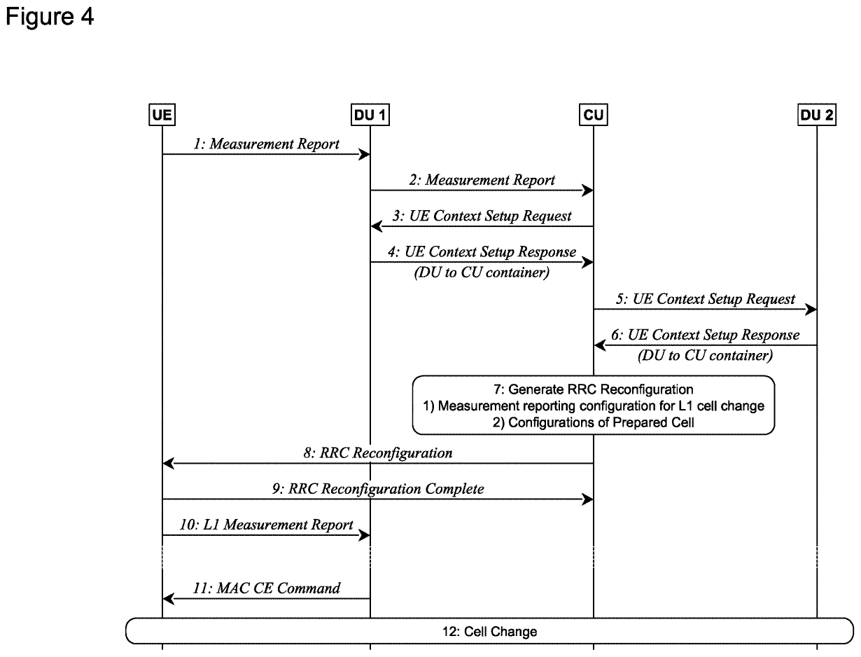

FIG. 4 shows an example signalling diagram of L1/2 inter-cell mobility from a serving cell in DU1 to a target cell in DU2 (inter-DU intra-centralised unit (CU) scenario). The same diagram would apply as well in case of intra-DU intra-CU cell change, where DU 1 is the same as DU2.

In step 1, the UE sends a measurement report containing the cell quality measurements of serving and neighboring cells. The UE may be configured by the serving cell to send the measurement report when it still has a good connection to the serving cell.

At step 2, DU1 sends the measurement report to a CU.

Using the reported cell quality measurements, the CU identifies a potential set of candidate target cells to which the UE can be handed over. In this example, the CU identifies candidate target cells that are served by DU1 (controlling the serving DU/cell as well) and another DU2 that is controlled by the same CU.

In step 3, the CU requests the preparation of a candidate target cell controlled by DU1 by sending UE Context Setup Request message to DU1.

In step 4, DU1 provides the configuration of the UE in UE Context Setup Response message containing a container from DU to CU.

The same steps 3 and 4 are performed as steps 5/6 with DU2 in order to prepare target cell(s) that are controlled by DU2.

Having received the UE configurations for the candidate target cell(s), the CU generates an RRC Reconfiguration that is sent to the UE in step 8. Among other information, the RRC Reconfiguration message contains a measurement reporting configuration for L1/2 handover, i.e., configuration on how to report the L1 beam measurements of serving and target cells in step 10 and configuration of the prepared candidate cell(s) which the UE needs to execute when it receives a MAC control element (CE) command to change the serving cell (perform handover) as shown in step 11.

After confirming the RRC Reconfiguration to the network in step 9, the UE starts to report periodically the L1 beam measurement of serving and candidate target cells as shown in step 10.

Upon determining that there is a target candidate cell having a better radio link/beam measurement than the serving cell, e.g., L1-reference signal received power (RSRP) of target beam measurement>L1-RSRP of serving beam measurement+Offset for an amount of time e.g., Time-to-Trigger (TTT), the serving cell sends a MAC Control Element (MAC CE) or a L1 message in step 11 to trigger the cell change to the target candidate cell.

The handover from serving cell to target cell is executed by the UE in step 12.

The release procedure of prepared cells for LLM procedures is yet to be agreed in 3GPP Rel. 18. The following relates to RRC-based release mechanism from CU-control plane (CP) based on L3 measurements.

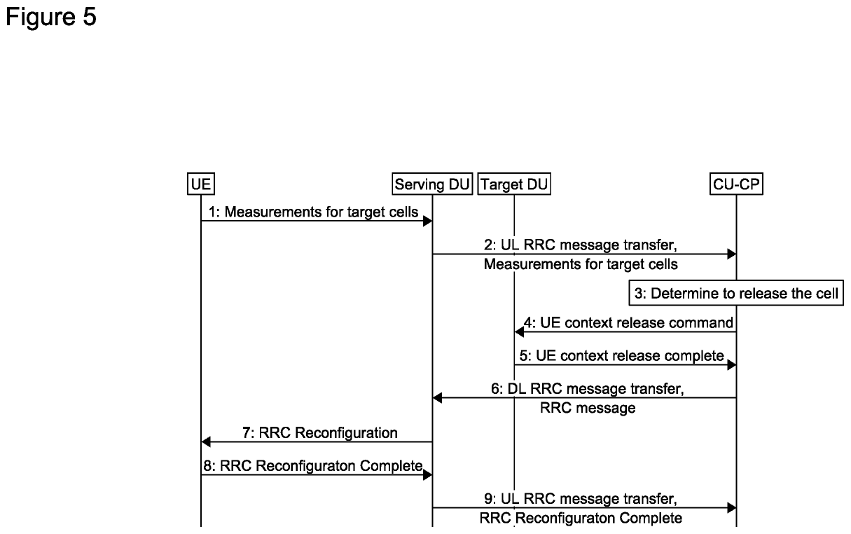

The same release procedure used for L3 mobility may be adopted for LLM. FIG. 5 shows a signalling procedure for a release procedure using L3 procedures.

In steps 1 and 3, the UE provides L3 measurements for serving and neighboring/target cells to the CU.

In step 3, based on the received measurements, the CU may determine to release a prepared target cell that is no longer useful for handover. For instance, the CU may decide to release a target cell whose radio signal measurement falls below a threshold or is much weaker than other prepared cells.

In steps 4 and 5, UE context is released from the target DU controlling one of the target cells to be released.

In step 6, the DL RRC message transfer is used to transfer transparently the RRCReconfiguration message to the UE.

In steps 7 to 9, the UE is reconfigured to release the configuration of the released target cell in step 7 and the confirmation is forwarded back to the CU in step 8 and 9.

A release procedure such as that shown in FIG. 5 requires the configuration of L3 measurement reports, despite LLM being configured to the UE (in other words reporting the L1 beam measurements of the prepared target cells to the serving DU). L1 and L3 measurements are performed and reported by UE. The L1 measurement reports at DU are not used for HO decision at CU.

The release procedure shown in FIG. 5 requires multiple F1 signaling, 6 messages in total, i.e., step 2, 4-7 and 10. RRC level signalling is sent to the UE and respective acknowledgement needs to be received from the UE. In total, there are three RRC messages (step 1, 8 and 9).

According to 3GPP specifications, a CU can use the RRC-reconfiguration to remove the conditional handover (CHO) configuration of a prepared target cell from the UE side.

This process is for L3 mobility procedures and is triggered by L3 measurements. The signalling remains the same as that of FIG. 5 and L3 measurements are required (to be configured) as well. It is not clear to what extent L3 measurements will be used for releasing the prepared target cells in LLM given that the UE will be already reporting L1 beam measurements for the prepared cells to the DU. As such the LLM preparation may not be executed until a UE handovers to another cell. After that, the UE and CU release all other prepared cells.

Not being able to timely release of the LLM preparation may cause resources to be reserved unnecessarily in multiple DUs or cells. The resource reservation overhead is a challenge which has been also emphasized in conditional handover (CHO). For this, 3GPP has defined CHO-cancel IE to enable the release of a prepared target cell that is no longer useful for handover. A similar problem will exist for LLM preparation.

Currently, UE preparation can only be released through RRC Reconfiguration. This procedure has to be controlled by the CU and may cause high signalling overhead as shown in FIG. 5.

The introduction of two sets of cells for L1/L2 based mobility, a Pre-configured set and an Active set, has been proposed. The pre-configured set is defined as the set of cells which are eligible and prepared for L1/L2 mobility at CU-CP and DU, but deactivated with respect to L1 measurement reporting by the UE. The gNB-DU is not expected to have reserved resources for such cells. In this proposal, the CU-CP indicates to the DU (in F1: UE context setup or UE context modification procedure) if a cell being prepared belongs to pre-configured set.

The Active set is defined as the set of cells which are eligible and prepared for L1/L2 mobility at CU-CP and DU, configured for L1 RSRP reporting by the UE, have resources reserved in the gNB-DU. CSI-RS transmission is also performed. The cells in the Active set are ready to take over as serving/assisting cell. TCI state configuration includes these cells. By configuring a UE with preconfigured and active sets, the network ensures that the L1 measurements are sent by UE to DU only for physical cell identities (PCI) of Active set.

This proposal is a pro-active signalling optimisation related to prepared cells. The cells are partially prepared to avoid measurement and resource reservation overhead. The proposal aims to activate only a subset of cells so that the amount of required release will be minimized.

Conditional cell release is provided in an alternative proposal. This condition is used by the UE to evaluate whether a cell of a cell group is to be released if the condition is met. The UE may be instructed to indicate to the network the release of this cell. Upon such indication the remapping or releasing of the bearers can occur. The condition for CPR (Conditional PSCell Release) can be one of the following: Ax measurement event, the lack of data in the transmission buffer or the loss of coverage provided by the configured cell.

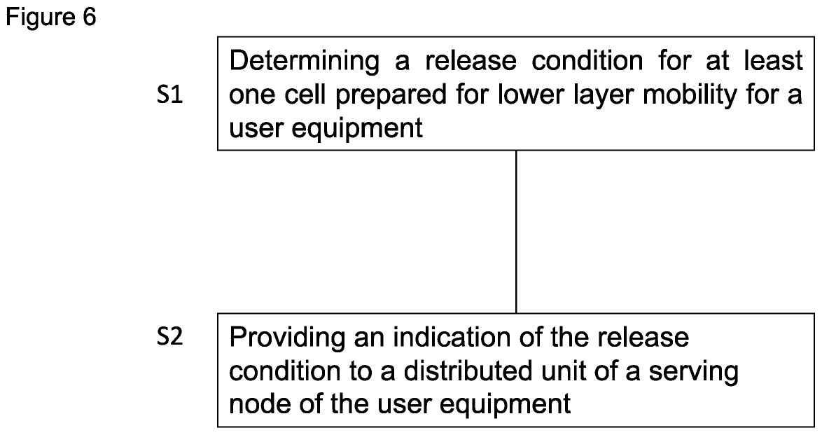

FIG. 6 shows a flowchart of a method according to an example embodiment. The method may be performed at a centralised unit, e.g. a centralised unit or CU-CP.

In S1, the method comprises determining a release condition for at least one cell prepared for lower layer mobility for a user equipment.

In S2, the method comprises providing an indication of the release condition to a distributed unit of a serving node of the user equipment.

The release condition may be the same or different for each of a plurality of cells prepared for lower layer mobility for a user equipment. In an example embodiment, CU determines a release condition for each LLM prepared cell. The condition may be the same or different for all prepared target cells.

CU configures the serving DU with the release condition for each prepared cell.

The method may comprise providing an indication of the release condition to the user equipment. The method may comprise providing a measurement configuration to the user equipment for enabling evaluation of the release condition. In an example embodiment, a CU configures the UE with the related measurements which are then used by the serving DU to evaluate the release conditions that are configured by the CU.

The release condition may comprise at least one of a threshold value, an offset value, a number of target cells and a target cell load. The threshold value may comprise at least one of reference signal received power, reference signal received quality and layer 1 signal to interference and noise ratio. The release condition may be referred to as a LLM release condition.

The LLM release condition may be based on radio conditions (L1 radio conditions obtained by L1 measurements). For example, L1 beam measurements of a prepared target cell X is below a certain value threshold Thr for a certain time duration T equal or higher than 0 or if L1 beam measurements of a target cell X is below the strongest measurement of prepared target cell by Y dB.

The parameters of the release condition such as threshold Thr, time duration T, offset Y may be provided by the CU to the DU.

The release condition may be a RSRP/reference signal received quality (RSRQ)/L1-signal to interference plus noise ratio (SINR) threshold. In a scenario where there is crunch of network resources, this may be useful.

Alternatively, or in addition, the LLM release condition may be based on the number of LLM prepared cells that the UE has currently. The maximum number may be, for example eight. As a result, the release of some cells may be necessary for the addition of the new ones. The LLM release condition may be based on the dynamic switching operation, where UE switches one of its non-serving cells with a serving cell.

In a scenario where a network has ample resources and prefers to optimize UE performance, the release condition may be coupled with the maximum number of prepared cells for a UE. i.e., a release will be triggered by the serving DU only when there is a new prepared cell to be configured for the UE. In other words, in this scenario, as long as the maximum limit of prepared cells is not reached, no release may be triggered.

The method may comprise determining the release condition based on at least one of RSRP threshold, the serving node associated with the target cell (e.g., whether the prepared cell is intra-DU or inter-DU), the total number of prepared cells for the user equipment and the load condition of the serving node associated with the target cell.

In an alternative embodiment, the release of a cell may trigger activation of an LLM preparation of another cell. This embodiment maybe called LLM preparation substitution.

The target cell may be associated with the distributed unit or a further distributed unit. In other words, a prepared cell may be an intra-DU or inter-DU cell. The release condition for all prepared cells is provided to the serving DU.

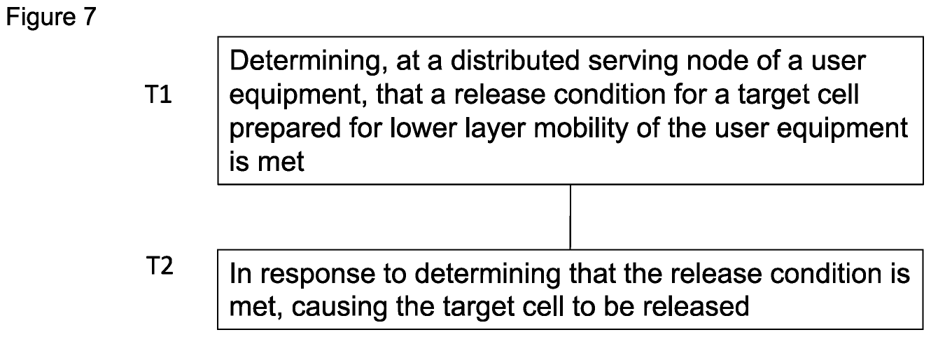

FIG. 7 shows a flowchart of a method according to an example embodiment. The method may be performed at a distributed unit of a serving node of a user equipment, for example a serving DU.

In T1, the method comprises determining, at a distributed serving node of a user equipment, that a release condition for a target cell prepared for lower layer mobility of the user equipment is met.

In T2, the method comprises, in response to determining that the release condition is met, causing the target cell to be released.

Causing the target cell to be released may comprise providing an indication to a centralised unit (e.g., CU-CP) indicating release preparation of the target cell.

In an example embodiment, a serving DU determines that the release condition holds for a target cell X.

The release condition may be as described above with reference to FIG. 6. The method may comprise, receiving, at the distributed unit of the serving node from a centralised unit, an indication of the release condition

In an example embodiment, the serving DU informs the CU-CP about the release of the prepared cell. The indication to the centralised unit may comprise an identifier of the target cell or a lower layer mobility preparation identifier.

The method may comprise receiving, at the distributed unit of the serving node, at least one layer 1 measurement value from the user equipment; and determining that the release condition for the target cell is met based on the at least one layer 1 measurement value.

In an example embodiment, the UE reports synchronisation signal block (SSB)-Resource Indicator (RI)-L or channel state information (CSI)-RI-L which contains least the CSI-reference signal (RS)/SSB of least RSRP values. DU decides on release based on multiple reports received for least RSRP values.

The method may comprise providing an indication to the user equipment to release the target cell. The indication to the user equipment may be provided in a layer 1 message, e.g., a MAC CE or downlink control information (DCI) indication. The indication to the user equipment may comprise an identifier of the target cell or a lower layer mobility preparation identifier.

In an example embodiment, when the release condition is met, the serving DU sends a MAC CE message to release the LLM prepared cell X at the UE, i.e., release the LLM configuration of prepared target cell X.

The indication to the user equipment may comprise an indication of whether layer 1 measurements for the target cell should be continued. For example, the MAC CE message indicating release of prepared cell configuration may also include whether UE should continue with the reporting configurations which includes CSI resources of this target cell or not as additional parameter.

The method may comprise providing a measurement configuration to the user equipment. For example, the DU may configure a CSI measurement reporting event to report least RSRP values of CSI-RS resource set or report SSB-RI or CSI-RS Resource Indicator (CRI) of resource which satisfies the condition for drop. The details of the autonomous release condition configured to the UE is related to other LLM preparations as such the number of LLM preparations may be indicated and/or configuration of filtering used at the DU, parameters for L1 filtering used at DU for LLM so the UE can decide when the preparation can be released.

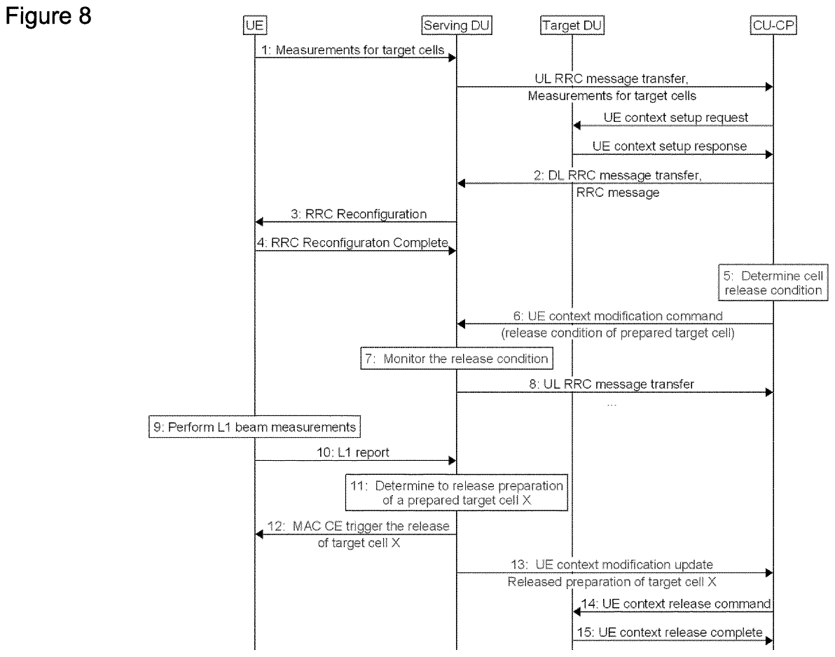

FIG. 8 shows a signalling diagram between a UE, serving DU, target DU and CU-CP.

In step 1, the UE sends L3 measurements of serving and neighboring target cell to DU. The serving DU forwards the L3 measurements transparently to CU. CU sets up UE context at the target DU controlling the target cell and receives the response.

In step 2, the CU-CP compiles RRC reconfiguration for the target cell as a part of LLM and sends this message to the Serving DU. CU indicates to the DU a LLM preparation ID.

Step 3 and 4 may be combined with this step for efficient signalling.

In step 3, the UE receives the LLM preparation with a measurement configuration enabling evaluation of the release condition at the serving DU. LLM preparation for each cell comes with a separate LLM preparation ID.

In step 4, UE acknowledges the new configuration and DU forwards this message to CU.

In step 5, the CU-CP determines the LLM release condition.

In step 6, the CU-CP sends a UE context modification message to the serving DU. The DU is informed about the UE context change and the release condition is appended.

In step 7, the DU starts monitoring the release condition. The serving DU evaluates the release condition using the L1 beam measurements that are received from the UE in step 10.

In an alternative embodiment, in case no e.g. radio threshold is provided to the DU, the DU may decide to release the LLM preparation based on its own evaluation of the radio conditions in step 11.

In steps 9 to 10, L1 measurements at the UE fulfill the criteria to be reported and UE sends reports to the serving DU.

In step 11, as a result of the release condition evaluation using the reported L1 beam measurements, the source DU determines to release LLM preparation of a target cell X.

In step 12, the source DU sends a MAC CE message to indicate an LLM preparation ID to be released. The source DU may indicate a list of LLM preparation IDs to the UE.

Alternatively, the serving DU may indicate the ID of the target cell to be released. In one alternative this message may be skipped (i.e., no MAC CE msg is sent).

In step 13, the source DU indicates to CU, the list of LLM preparation IDs that are released from UE side. Alternatively, the serving DU indicates to the CU the ID of the target cell to be released.

In one alternative, the Source DU indicates this message without sending message in step 12 to the UE. This indicates that source DU will not trigger LLM for that cell. CU can proceed to release the target cell.

In step 14 and 15, the CU notifies the target DU about the release of the LLM preparation. The target DU releases resources reserved for LLM preparation. Steps 14 and 15 may not be needed for intra-DU mobility scenario.

In the scenario involving the introduction of two sets of cells for L1/L2 based mobility (the Pre-configured set and the Active set), if the network prefers to retain the prepared cell configuration of the UE (without reserving resources in the respective DUs), the prepared cell release may be modified to include two steps.

Firstly, moving a prepared cell from “Active set” to “preconfigured set”. This triggers release of reserved resources at the network side, but the prepared cell configuration is retained at both UE and network.

Secondly, releasing the prepared cell configuration from the “preconfigured set”. This triggers release of reserved resources as well as the prepared cell configuration at both UE and network.

This may require two separate release conditions to be defined as a modification to step 3-4 in MSC of FIG. 8. Furthermore, two separate release operation by the serving DU i) releasing the cell from pre-configured set and ii) moving the cell back from active set to preconfigured set as a modification to step 11-12 in MSC of FIG. 8.

The method as described with reference to FIGS. 6 to 8, may remove, at a minimum, one F1 round trip time (RTT) delay between CU and DU when releasing the configured target cell at the UE (10-20 ms reduction assuming 5-10 ms one way delay between CU and DU).

The idea may be useful for high RTT scenarios with very long F1 links, such as high altitude platforms (HAPS) or non-terrestrial network (NTN) scenarios. There may be quicker adjustments to signal conditions toward the UE, which could be useful for higher frequencies where conditions can change very quickly.

An apparatus may comprise means for determining, at a distributed unit of a serving node of a user equipment, that a release condition for a target cell prepared for lower layer mobility of the user equipment is met and in response to determining that the release condition is met, causing the target cell to be released.

An apparatus may comprise means for determining for at least one cell prepared for lower layer mobility for a user equipment, a release condition and providing an indication of the release condition to a distributed unit of a serving node of the user equipment.

Alternatively, an apparatus may comprise means for receiving, from a centralised unit at a distributed unit of a serving node of a user equipment, an indication of a release condition for at least one cell prepared for lower layer mobility for the user equipment.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst some embodiments have been described in relation to 5G networks, similar principles can be applied in relation to other networks and communication systems. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

In general, the various embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the FIGS. may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media. The term “non-transitory,” as used herein, is a limitation of the medium itself (i.e., tangible, not a signal) as opposed to a limitation on data storage persistency (e.g., RAM vs. ROM).

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various embodiments of the disclosure is set out by the independent claims. The embodiments and features, if any, described in this specification that do not fall under the scope of the independent claims are to be interpreted as examples useful for understanding various embodiments of the disclosure.

The foregoing description has provided by way of non-limiting examples a full and informative description of the exemplary embodiment of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further embodiment comprising a combination of one or more embodiments with any of the other embodiments previously discussed.

1. An apparatus comprising: at least one processor and at least one memory storing instructions that, when executed by the at least one processor, cause the apparatus at least to:
determine, at a distributed unit of a serving node of a user equipment, that a release condition for a target cell prepared for lower layer mobility of the user equipment is met; and
in response to determining that the release condition is met, cause the target cell to be released.

2. An apparatus according to claim 1, wherein the apparatus is configured to cause the target cell to be released by providing an indication to a centralised unit indicating release preparation of the target cell.

3. An apparatus according to claim 2, wherein the indication to the centralised unit comprises an identifier of the target cell or a lower layer mobility preparation identifier.

4. An apparatus according to claim 1, wherein the apparatus is further configured to receive, at the distributed unit of the serving node, at least one layer 1 measurement value from the user equipment; and to
determine that the release condition for the target cell is met based on the at least one layer 1 measurement value.

5. An apparatus according to claim 1, wherein the apparatus is configured to cause the target cell to be released by providing an indication to the user equipment to release a configuration of the target cell.

6. An apparatus according to claim 5, wherein the indication to the user equipment is provided in a layer 1 message.

7. An apparatus according to claim 6, wherein the layer 1 message comprises a media access control, MAC, control element, CE or downlink control information, DCI, indication.

8. An apparatus according to claim 5, wherein the indication to the user equipment comprises an indication of whether layer 1 measurements for the target cell should be continued.

9. An apparatus according to claim 5, wherein the indication to the user equipment comprises an identifier of the target cell or a lower layer mobility preparation identifier.

10. An apparatus according to claim 1, wherein the release condition comprises at least one of a threshold value, an offset value, a number of target cells and a target cell load.

11. An apparatus according to claim 10, wherein the threshold value comprises at least one of reference signal received power, reference signal received quality and layer 1 signal to interference and noise ratio.

12. An apparatus according to claim 1, wherein the apparatus is further configured to receive, at the distributed unit of the serving node from a centralised unit, an indication of the release condition.

13. A method comprising:
determining, at a distributed unit of a serving node of a user equipment, that a release condition for a target cell prepared for lower layer mobility of the user equipment is met; and
in response to determining that the release condition is met, causing the target cell to be released.

14. (canceled)

15. A non-transitory computer readable medium comprising instructions which, when executed by an apparatus, cause the apparatus to perform at least the method according to claim 13.

16-26. (canceled)

27. An apparatus comprising: at least one processor and at least one memory storing instructions that, when executed by the at least one processor, cause the apparatus at least to:
determine for at least one cell prepared for lower layer mobility for a user equipment, a release condition; and
provide an indication of the release condition to a distributed unit of a serving node of the user equipment.

28. An apparatus comprising: at least one processor and at least one memory storing instructions that, when executed by the at least one processor, cause the apparatus at least to:
receive, from a centralised unit at a distributed unit of a serving node of a user equipment, an indication of a release condition for at least one cell prepared for lower layer mobility for the user equipment.

29-30. (canceled)
